(19) United States
(12) Patent Application Publication
(10) Pub. No.: US 2024/0257254 A1
(43) Pub. Date: Aug. 1, 2024

(54) SYSTEMS AND METHODS FOR GENERATING PERSONALIZED ASSET ALLOCATION GLIDEPATHS

(71) Applicant: Capital One Services, LLC, McLean, VA (US)

(72) Inventors: Elizabeth Sabin, Arlington, VA (US); Daniel Serino, North Bethesda, MD (US)

(21) Appl. No.: 18/162,803

(22) Filed: Feb. 1, 2023

(51) Int. Cl. G06Q 40/06

(52) U.S. Cl. CPC G06Q 40/06

(57) ABSTRACT

Disclosed embodiments may include a system for generating personalized asset allocation glidepaths. The system may receive data corresponding to a user. The system may cause a user device to display a graphical user interface (GUI) that includes a plurality of editable fields associated with the data. The system may monitor the plurality of editable fields for edits. The system may dynamically generate a personalized asset allocation glidepath of the user based on the monitoring of the plurality of editable fields.

The disclosed technology relates to systems and methods for generating personalized asset allocation glidepaths. Specifically, this disclosed technology relates to generating personalized asset allocation glidepaths by determining individual asset allocations associated with a plurality of time segments.

### BACKGROUND

Personalized asset allocation glidepaths provide a way in which individuals can budget and plan for certain life events, such as retirement, a purchase of a major asset (e.g., a house), investment in a child's education, and the like. Traditional systems and methods for developing personalized asset allocation glidepaths typically involve generating asset allocations as a mix of, for example, stocks and bonds, where the mix may change over time as individuals move closer toward these life events. These traditional systems and methods not only involve guesswork to ensure individuals' investments are allocated properly over time, but also typically consider individuals' preferred asset allocations as inputs to the overall determination, which can lower the probability of achieving a financial goal.

Accordingly, there is a need for improved systems and methods for generating personalized asset allocation glidepaths. Embodiments of the present disclosure are directed to this and other considerations.

### SUMMARY

Disclosed embodiments may include a system for generating personalized asset allocations. The system may include one or more processors, and memory in communication with the one or more processors and storing instructions that, when executed by the one or more processors, are configured to cause the system to generate a personalized asset allocation. The system may receive data corresponding to a user, the data comprising a risk tolerance and an end time associated with a life event. The system may cause a user device to display a graphical user interface (GUI) that includes a plurality of editable fields associated with the data. The system may monitor the plurality of editable fields for edits. The system may dynamically generate a personalized asset allocation glidepath of the user based on the monitoring of the plurality of editable fields by, for each edit of a plurality of edits to the plurality of fields: determining an amount of time between a current time and the end time; dividing the amount of time into a plurality of time segments; using a current state of the plurality of fields to determine an asset allocation for each of the plurality of time segments via a neural network; and causing the user device to update the GUI with the asset allocation based on the current state of the plurality of fields, such that the asset allocation is dynamically updated with each edit of the plurality of edits, the asset allocation being configured to maximize a probability that the user will retain a threshold amount of money at the end time associated with the life event.

Disclosed embodiments may include a system for generating personalized asset allocations. The system may include one or more processors, and memory in communication with the one or more processors and storing instructions that, when executed by the one or more processors, are configured to cause the system to generate a personalized asset allocation. The system may receive data corresponding to a user, the data comprising a risk tolerance and an end time associated with a life event. The system may cause a user device to display a GUI that includes a plurality of editable fields associated with the data. The system may monitor the plurality of editable fields for edits. The system may dynamically generate a personalized asset allocation glidepath of the user based on the monitoring of the plurality of editable fields by, for each edit of a plurality of edits to the plurality of fields: determining an amount of time between a current time and the end time; dividing the amount of time into a plurality of time segments; using a current state of the plurality of fields to determine an asset allocation for each of the plurality of time segments via a neural network; and causing the user device to update the GUI with the asset allocation based on the current state of the plurality of fields, such that the asset allocation is dynamically updated with each edit of the plurality of edits, the asset allocation being configured to maximize a probability of success.

Disclosed embodiments may include a system for generating personalized asset allocations. The system may include one or more processors, and memory in communication with the one or more processors and storing instructions that, when executed by the one or more processors, are configured to cause the system to generate a personalized asset allocation. The system may receive data corresponding to a user. The system may determine an amount of time based on the data. The system may divide the amount of time into a plurality of time segments. The system may determine an asset allocation for each of the plurality of time segments via a neural network based on the data, the asset allocation being configured to maximize a probability that the user will achieve a life goal. The system may generate a personalized asset allocation glidepath associated with the life goal based on each asset allocation for each of the plurality of time segments.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for generating personalized asset allocation glidepaths, in accordance with certain embodiments of the disclosed technology.

FIG. 2 is block diagram of an example simulation system used for generating personalized asset allocation glidepaths, according to an example implementation of the disclosed technology.

FIG. 3 is block diagram of an example system that may be used for generating personalized asset allocation glidepaths, according to an example implementation of the disclosed technology.

FIG. 4A is a flow diagram illustrating an exemplary method for generating personalized asset allocation glidepaths, in accordance with certain embodiments of the disclosed technology.

FIG. 4B is a flow diagram illustrating a series of steps included within block 408 of FIG. 4A.

### DETAILED DESCRIPTION

Traditional systems and methods for generating personalized asset allocation glidepaths typically involve using a potentially optimal asset allocation as a starting point or input, and determining how an individual's financial portfolio may look at the end of a certain period of time based on the inputted potentially optimal asset allocation. Based on how well the outputted financial portfolio appears with respect to the individual's life and/or financial goals, the optimal asset allocation may be adjusted as a new input. As such, traditional systems and methods for generating personalized asset allocation glidepaths require trial and error, and typically do not take into account an individual's cash inflows and outflows as the individual approaches the end of the certain period of time, or the occurrence of a specified future life event.

Accordingly, examples of the present disclosure may relate to systems and methods for generating personalized asset allocation glidepaths. More particularly, the disclosed technology may relate to generating personalized asset allocation glidepaths by determining individual asset allocations associated with a plurality of time segments evaluated simultaneously. For example, the disclosed technology may provide for receiving data corresponding to a user (e.g., cash inflow and outflow data), determining an amount of time until the occurrence of a life event (e.g., retirement), dividing the amount of time into a plurality of smaller time segments, and simultaneously determining an asset allocation for each of the smaller time segments so as to maximize a probability that the user will still have a threshold amount of money at the occurrence of the life event. Additionally, the disclosed technology may provide for generating a personalized asset allocation glidepath based on each asset allocation associated with each smaller time segment.

Disclosed embodiments may employ machine learning models (MLMs), among other computerized techniques, to simultaneously determine an asset allocation for each of the smaller time segments based on the received user data. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to determine each asset allocation by performing simulations (e.g., Monte Carlo simulations) for each of the time segments. This, in some examples, may involve using user-specific input data (e.g., cash inflows and outflows) and a neural network, applied to determine asset allocations to maximize a probability that the user will retain a predefined amount of money by the time the user reaches the life event (e.g., retirement). Using an MLM in this way may allow the system to generate a personalized asset allocation glidepath as a system output to provide to a user. This is a clear advantage and improvement over prior technologies that use an asset allocation as a system input to then determine whether that asset allocation may provide a user with a desired financial portfolio or status at a future time. The present disclosure solves this problem by providing the generation or outputting of a personified asset allocation glidepath based on a simultaneous determination of individual asset allocations associated with shorter time segments.

Furthermore, examples of the present disclosure may also improve the speed with which computers can generate personalized asset allocation glidepaths. The systems and methods disclosed herein require higher processing power (e.g., through Amazon Web Services (AWS)) compared to traditional systems and methods. In addition, the systems and methods disclosed herein require the ability to run detailed Monte Carlo simulations, and to input significant amounts of detailed cash flow data associated with individuals. Overall, the systems and methods disclosed herein have significant practical applications in the customized asset allocation glidepath field because of the noteworthy improvements of conducting complex mathematical calculations requiring significant computational demand, and overcoming challenges in current regulatory environments (e.g., rendering obsolete the need to request individuals complete a Risk Tolerance Questionnaire (RTQ)), which are important to solving present problems with this technology.

As used herein, “asset allocation” may mean a breakdown of an investment portfolio into specific asset classes in which it is invested. For example, a $100 portfolio with $60 in equities and $40 in bonds would have an asset allocation of 60% equities and 40% bonds. Traditionally, investors have distinguished cash, equities, bonds, and real estate as the major asset classes. This list has recently been expanded to include private equity, hedge funds, commodities, and/or other assets, such as art, and intellectual property rights. These “newer” asset classes sometimes get grouped together as alternative investments. Sub-asset classes can also be distinguished as part of an asset allocation.

As used herein, “capital market assumptions” may mean that for each asset class, there is a stochastic model for how annualized returns behave. This model may supply the expected (e.g., mean) return and the standard deviation. The model may have a standard normal distribution (e.g., a bell curve), and the algorithm utilized may generate random numbers in this distribution to simulate how these asset classes behave. In each simulation, a different set of random numbers may be used, which may help to create a wide array of financial scenarios.

As used herein, “cash flow” may mean the net amount of cash and cash equivalents being transferred in and out over someone's lifetime. Cash received represents inflows, while money spent represents outflows. A person's ability to create net worth is fundamentally determined by their ability to generate positive cash flows.

As used herein, “glidepath” may mean a formula that defines the asset allocation mix over time, typically depicted with time on the x-axis and asset allocation breakdown on the y-axis (expressed as a percentage).

As used herein, a “goal” may mean a monetary target an individual strives to hit, such as saving for a wedding, or eliminating student loan debt.

As used herein, a “life event” may include, for example, birth or adoption of a child, higher education and/or training, establishment of life partners, home ownership, unplanned events, employment, owning a business, planning for retirement, retiring, and death of a family member.

As used herein, “gross income” may mean an individual's total earnings in the form of, for example, wages, salaries, returns on investments, sales of property, and other receipts.

As used herein, “net income” may mean an individual's gross income reduced by costs incurred in producing the gross income.

As used herein, “Monte Carlo simulation” may mean a simulation used to model the probability of different outcomes in a process that cannot easily be predicted due to the intervention of random variables. A Monte Carlo simulation is a technique used to understand the impact of risk and uncertainty in prediction and forecasting models. A Monte Carlo simulation can be used to tackle a range of problems in virtually every field such as finance, engineering, supply chain, and science. It is also referred to as a multiple probability simulation.

As used herein, “probability of success” may mean the optimization of a model's estimate, for example, the number of successful trials divided by the number of simulations. A utilized algorithm may choose an appropriate number of Monte Carlo trials to balance accuracy and computational efficiency. The model can simulate one or more financial scenarios an individual may encounter throughout their lifetime, allowing for a robust optimization of the eventual resulting asset allocation glidepath.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

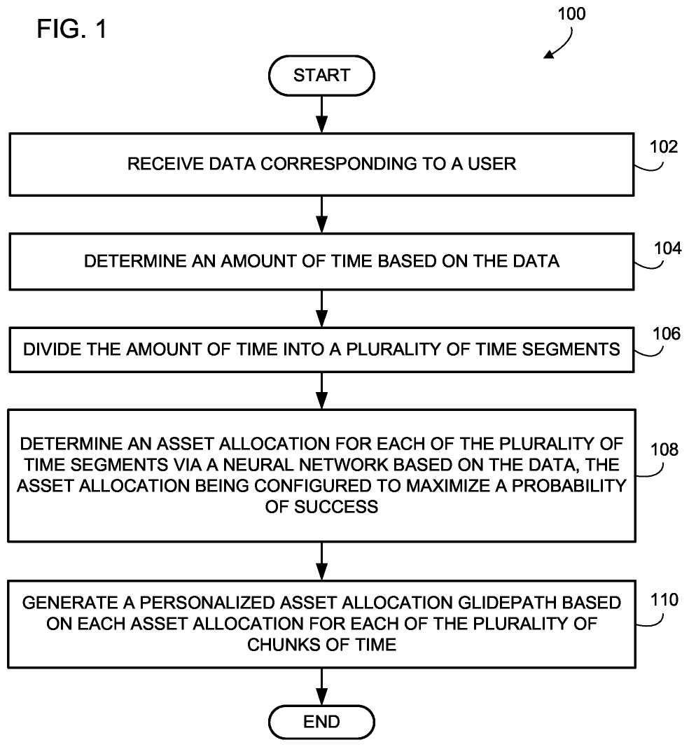

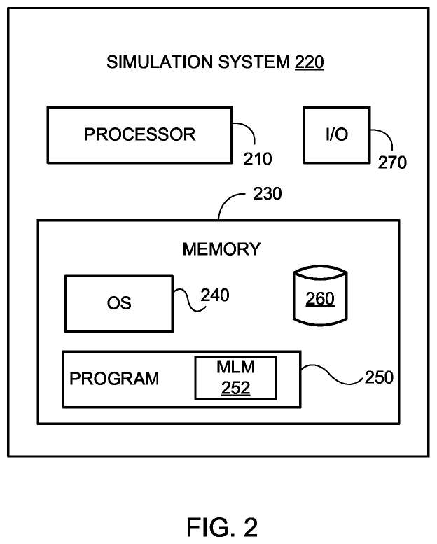

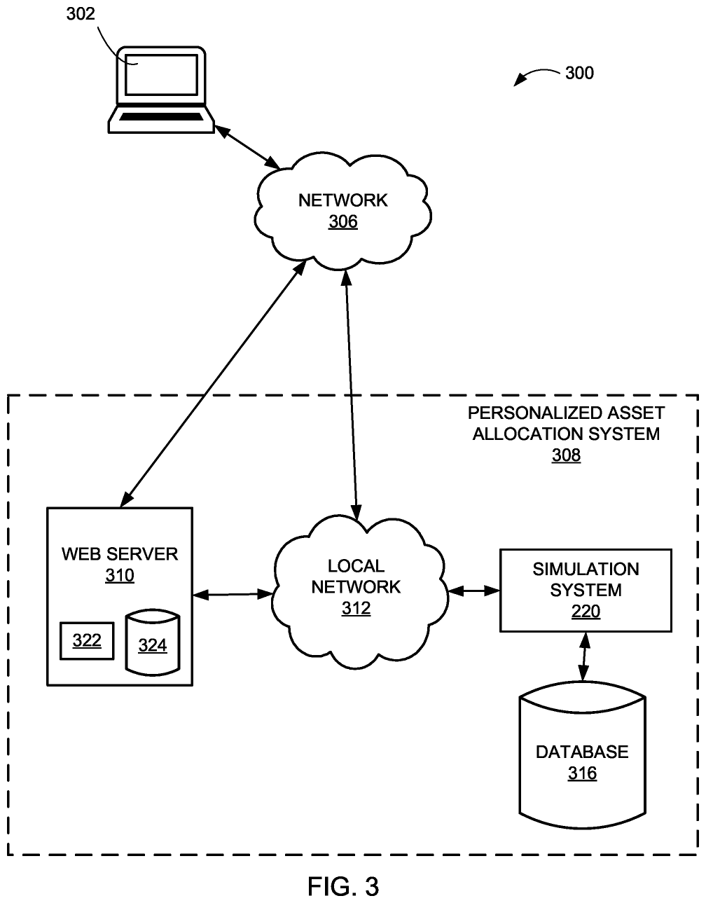

FIG. 1 is a flow diagram illustrating an exemplary method 100 for generating personalized asset allocation glidepaths, in accordance with certain embodiments of the disclosed technology. The steps of method 100 may be performed by one or more components of the system 300 (e.g., simulation system 220 or web server 310 of personalized asset allocation system 308 or user device 302), as described in more detail with respect to FIGS. 2 and 3.

In block 102, the simulation system 220 may receive data corresponding to a user. In some embodiments, the data may include information associated with various cash inflows and outflows of the user. Cash inflows may include, for example, income, salary, rental income, intellectual property, royalties, and the like. Cash outflows may include, for example, tax information, life goals (e.g., retirement, education payments, asset purchases, etc.), life events (e.g., birth or adoption of a child, expected inheritance, bequests, etc.), and the like. In some embodiments, the data may include a risk tolerance (e.g., the user's preference as to how risk adverse they'd like to be) and an end time associated with a life event. For example, the life event may be the user's retirement, which the user may plan to begin when the user turns 62 years old (the end time).

In block 104, the simulation system 220 may determine an amount of time based on the data. For example, the system may determine an amount of time between the current time and the end time (e.g., when the user turns 62 years old, as in the above example). In some embodiments, the amount of time may be measured in years such that the system has an indication as to how many years may pass until the user's planned life event occurs.

In block 106, the simulation system 220 may divide the amount of time into a plurality of time segments. In continuing with the above example, if the user is currently 42 years old, and wishes to retire at the age of 62, the system may determine the amount of time (block 104) to be 20 years. The system may then divide that 20 years into 20, one-year time segments. Alternatively, for example, the system may divide that 20 years into 10, two-year time segments.

In block 108, the simulation system 220 may determine an asset allocation for each of the plurality of time segments via a neural network based on the data, the asset allocation being configured to maximize a probability of success. In some embodiments, the system may be configured to determine each asset allocation simultaneously. If continuing with the above example, if the system divided the 20 years into 20, one-year time segments, the system may simultaneously determine an asset allocation for the user between the ages of 61 and 62 years old, 60 and 61 years old, 59 and 60 years old, etc., until the system reaches the time segment when the user is between 42 and 43 years old.

The system may simultaneously determine an asset allocation for each of the individual or smaller time segments. In some embodiments, the system may utilize a neural network to determine such asset allocations. For example, the neural network may be configured to perform one or more simulations (e.g., Monte Carlo simulations) that are based on one or more algorithms, for each time segment, to determine an asset allocation that aims to maximize a probability of success. In some embodiments, the neural network may be configured to perform backpropagation to compute sensitivities with respect to each individual time segment's asset allocation. In such embodiments, the system may be configured to adjust respective weights of each asset allocation by the respective computed sensitivities, and to recompute the sensitivities via backpropagation until the sensitives converge at an optimal or customized glidepath for a user.

In some embodiments, the probability of success may include a probability that the user will retain a threshold amount of money (e.g., predefined by the user or a financial advisor) at the end time associated with the life event. For example, the user may predefine a certain amount of money he/she would prefer to have when the user retires at the age of 62. In some embodiments, the probability of success may include a probability that the user will achieve a life goal (e.g., having enough money at a certain time to purchase a new asset).

In block 110, the simulation system 220 may generate a personalized asset allocation glidepath based on each asset allocation for each of the plurality of time segments. As discussed herein, the system may be configured to output an optimized asset allocation glidepath customized to a specific user to maximize a probability of success of achieving an end goal and/or maintaining a threshold amount of money at the future time associated with the user's planned life event (e.g., retirement), based on all determined asset allocations for all evaluated time segments.

FIG. 2 is a block diagram of an example simulation system 220 used to generate personalized asset allocation glidepaths, according to an example implementation of the disclosed technology. According to some embodiments, the user device 302 and web server 310, as depicted in FIG. 3 and described below, may have a similar structure and components that are similar to those described with respect to simulation system 220 shown in FIG. 2. As shown, the simulation system 220 may include a processor 210, an input/output (I/O) device 270, a memory 230 containing an operating system (OS) 240 and a program 250. In some embodiments, program 250 may include an MLM 252 that may be trained, for example, to determine asset allocations for individual time segments based on received user data. In certain implementations, MLM 252 may issue commands in response to processing an event, in accordance with a model that may be continuously or intermittently updated. Moreover, processor 210 may execute one or more programs (such as via a rules-based platform or the trained MLM 252), that, when executed, perform functions related to disclosed embodiments.

In certain example implementations, the simulation system 220 may be a single server or may be configured as a distributed computer system including multiple servers or computers that interoperate to perform one or more of the processes and functionalities associated with the disclosed embodiments. In some embodiments simulation system 220 may be one or more servers from a serverless or scaling server system. In some embodiments, the simulation system 220 may further include a peripheral interface, a transceiver, a mobile network interface in communication with the processor 210, a bus configured to facilitate communication between the various components of the simulation system 220, and a power source configured to power one or more components of the simulation system 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™4 port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the simulation system 220 may include one or more storage devices configured to store information used by the processor 210 (or other components) to perform certain functions related to the disclosed embodiments. In one example, the simulation system 220 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The simulation system 220 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the simulation system 220 may include the memory 230 that may include one or more programs 250 to perform one or more functions of the disclosed embodiments. For example, in some embodiments, the simulation system 220 may additionally manage dialogue and/or other interactions with the customer via a program 250.

The processor 210 may execute one or more programs 250 located remotely from the simulation system 220. For example, the simulation system 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a prediction system database 260 for storing related data to enable the simulation system 220 to perform one or more of the processes and functionalities associated with the disclosed embodiments.

The prediction system database 260 may include stored data relating to status data (e.g., average session duration data, location data, idle time between sessions, and/or average idle time between sessions) and historical status data. According to some embodiments, the functions provided by the prediction system database 260 may also be provided by a database that is external to the simulation system 220, such as the database 316 as shown in FIG. 3.

The simulation system 220 may also be communicatively connected to one or more memory devices (e.g., databases) locally or through a network. The remote memory devices may be configured to store information and may be accessed and/or managed by the simulation system 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The simulation system 220 may also include one or more I/O devices 270 that may comprise one or more interfaces for receiving signals or input from devices and providing signals or output to one or more devices that allow data to be received and/or transmitted by the simulation system 220. For example, the simulation system 220 may include interface components, which may provide interfaces to one or more input devices, such as one or more keyboards, mouse devices, touch screens, track pads, trackballs, scroll wheels, digital cameras, microphones, sensors, and the like, that enable the simulation system 220 to receive data from a user (such as, for example, via the user device 302).

In examples of the disclosed technology, the simulation system 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The simulation system 220 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another MLM. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The simulation system 220 may be configured to adjust model parameters during training. Model parameters may include weights, coefficients, offsets, or the like. Training may be supervised or unsupervised.

The simulation system 220 may be configured to train MLMs by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The simulation system 220 may be configured to optimize statistical models using known optimization techniques.

Furthermore, the simulation system 220 may include programs configured to retrieve, store, and/or analyze properties of data models and datasets. For example, simulation system 220 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other MLM.

The simulation system 220 may include algorithms to determine a data type, key-value pairs, row-column data structure, statistical distributions of information such as keys or values, or other property of a data schema may be configured to return a statistical profile of a dataset (e.g., using a data-profiling model). The simulation system 220 may be configured to implement univariate and multivariate statistical methods. The simulation system 220 may include a regression model, a Bayesian model, a statistical model, a linear discriminant analysis model, or other classification model configured to determine one or more descriptive metrics of a dataset. For example, simulation system 220 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The simulation system 220 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, simulation system 220 may be configured to generate a similarity metric representing a measure of similarity between data in a dataset. A similarity metric may be based on a correlation, covariance matrix, a variance, a frequency of overlapping values, or other measure of statistical similarity.

The simulation system 220 may be configured to generate a similarity metric based on data model output, including data model output representing a property of the data model. For example, simulation system 220 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The simulation system 220 may be configured to classify a dataset. Classifying a dataset may include determining whether a dataset is related to another dataset(s). Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as a node diagram, a tree diagram, or a vector diagram of datasets. Classifying a dataset may include estimating a likelihood that a dataset relates to another dataset, the likelihood being based on the similarity metric.

The simulation system 220 may include one or more data classification models to classify datasets based on the data schema, statistical profile, and/or edges. A data classification model may include a convolutional neural network, a random forest model, a recurrent neural network model, a support vector machine model, or another MLM. A data classification model may be configured to classify data elements as actual data, synthetic data, related data, or any other data category. In some embodiments, simulation system 220 is configured to generate and/or train a classification model to classify a dataset, consistent with disclosed embodiments.

The simulation system 220 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via weighted connections. Prediction models may additionally or alternatively include classification and regression trees, or other types of models known to those skilled in the art. To generate prediction models, the prediction system may analyze information applying machine-learning methods.

While the simulation system 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the simulation system 220 may include a greater or lesser number of components than those illustrated.

FIG. 3 is a block diagram of an example system that may be used to view and interact with personalized asset allocation system 308, according to an example implementation of the disclosed technology. The components and arrangements shown in FIG. 3 are not intended to limit the disclosed embodiments as the components used to implement the disclosed processes and features may vary. As shown, personalized asset allocation system 308 may interact with a user device 302 via a network 306. In some embodiments, the personalized asset allocation system 308 may include a local network 312, a simulation system 220, a web server 310, and a database 316.

In some embodiments, a user may operate the user device 302. The user device 302 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 306 and ultimately communicating with one or more components of the personalized asset allocation system 308. In some embodiments, the user device 302 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the personalized asset allocation system 308. According to some embodiments, the user device 302 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 306 may be of any suitable type, including individual connections via the internet such as cellular or WiFi™ networks. In some embodiments, the network 306 may connect terminals, services, and mobile devices using direct connections such as RFID, NFC, Bluetooth™ BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 306 may include any type of computer networking arrangement used to exchange data. For example, the network 306 may be the Internet, a private data network, virtual private network (VPN) using a public network, and/or other suitable connection(s) that enable(s) components in the system 300 environment to send and receive information between the components of the system 300. The network 306 may also include a PSTN and/or a wireless network.

The personalized asset allocation system 308 may be associated with and optionally controlled by one or more entities such as a business, corporation, individual, partnership, or any other entity that provides one or more of goods, services, and consultations to individuals such as customers. In some embodiments, the personalized asset allocation system 308 may be controlled by a third party on behalf of another business, corporation, individual, partnership. The personalized asset allocation system 308 may include one or more servers and computer systems for performing one or more functions associated with products and/or services that the organization provides.

Web server 310 may include a computer system configured to generate and provide one or more websites accessible to customers, as well as any other individuals involved in accessing personalized asset allocation system 308's normal operations. Web server 310 may include a computer system configured to receive communications from user device 302 via for example, a mobile application, a chat program, an instant messaging program, a voice-to-text program, an SMS message, email, or any other type or format of written or electronic communication. Web server 310 may have one or more processors 322 and one or more web server databases 324, which may be any suitable repository of website data. Information stored in web server 310 may be accessed (e.g., retrieved, updated, and added to) via local network 312 and/or network 306 by one or more devices or systems of system 300. In some embodiments, web server 310 may host websites or applications that may be accessed by the user device 302. For example, web server 310 may host a financial service provider website that a user device may access by providing an attempted login that is authenticated by the simulation system 220. According to some embodiments, web server 310 may include software tools, similar to those described with respect to user device 302 above, that may allow web server 310 to obtain network identification data from user device 302. The web server may also be hosted by an online provider of website hosting, networking, cloud, or backup services, such as Microsoft Azure™ or Amazon Web Services™.

The local network 312 may include any type of computer networking arrangement used to exchange data in a localized area, such as WiFi™, Bluetooth™, Ethernet, and other suitable network connections that enable components of the personalized asset allocation system 308 to interact with one another and to connect to the network 306 for interacting with components in the system 300 environment. In some embodiments, the local network 312 may include an interface for communicating with or linking to the network 306. In other embodiments, certain components of the personalized asset allocation system 308 may communicate via the network 306, without a separate local network 306.

The personalized asset allocation system 308 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 302 may be able to access personalized asset allocation system 308 using the cloud computing environment. User device 302 may be able to access personalized asset allocation system 308 using specialized software. The cloud computing environment may eliminate the need to install specialized software on user device 302.

In accordance with certain example implementations of the disclosed technology, the personalized asset allocation system 308 may include one or more computer systems configured to compile data from a plurality of sources, such as the simulation system 220, web server 310, and/or the database 316, for example. The simulation system 220 may correlate compiled data, analyze the compiled data, arrange the compiled data, generate derived data based on the compiled data, and store the compiled and derived data in a database such as the database 316. According to some embodiments, the database 316 may be a database associated with an organization and/or a related entity that stores a variety of information relating to customers, transactions, ATM, and business operations. The database 316 may also serve as a back-up storage device and may contain data and information that is also stored on, for example, database 260, as discussed with reference to FIG. 2.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

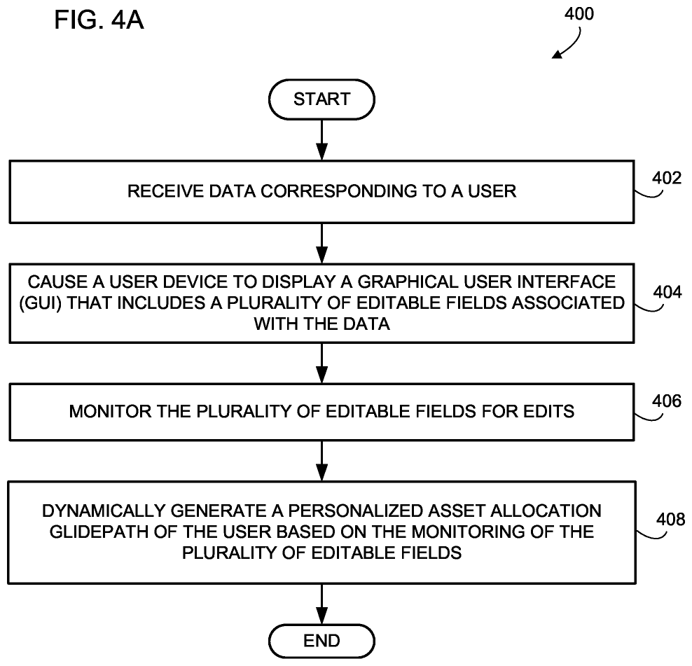

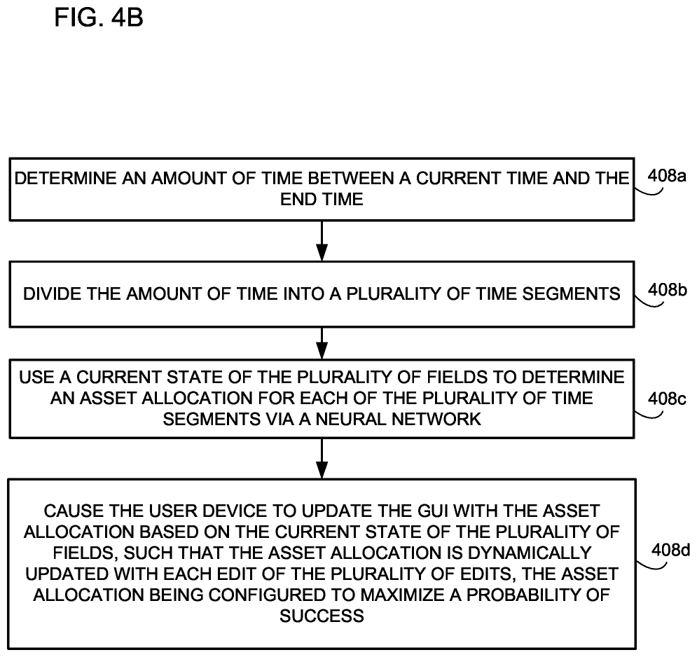

FIG. 4A is a flow diagram illustrating an exemplary method 400 for generating personalized asset allocation glidepaths, in accordance with certain embodiments of the disclosed technology. The steps of method 400 may be performed by one or more components of the system 300 (e.g., simulation system 220 or web server 310 of personalized asset allocation system 308 or user device 302), as described above with respect to FIGS. 2 and 3. FIG. 4B is a series of steps included in block 408 of FIG. 4A, and as such, FIGS. 4A-4B are discussed simultaneously herein.

In block 402, the simulation system 220 may receive data corresponding to a user. This step may be the same as or similar to block 102 of method 100, as discussed above with respect to FIG. 1.

In block 404, the simulation system 220 may cause a user device to display a GUI that includes a plurality of editable fields associated with the data. In some embodiments, the editable fields may include selectable user input objects, such as a click button, text box, drop-down menu, and the like.

In block 406, the simulation system 220 may monitor the plurality of editable fields for edits. For example, the system may monitor whether any of the editable fields have been altered or changed, such as by a user inputting different information into the fields.

In block 408, the simulation system 220 may dynamically generate a personalized asset allocation glidepath of the user based on the monitoring of the plurality of editable fields. For example, the system may be configured to continuously modify a generated personalized asset allocation glidepath based on any changes to the data entered into the editable fields.

As illustrated in FIG. 4B, the system may dynamically generate the personalized allocation glidepath (block 408 of FIG. 4A) by performing a series of steps for each edit of a plurality of edits to the plurality of fields.

In block 408a, the simulation system 220 may determine an amount of time between a current time and the end time. This step may be the same as or similar to block 104 of method 100, as discussed above with respect to FIG. 1.

In block 408b, the simulation system 220 may divide the amount of time into a plurality of time segments. This step may be the same as or similar to block 106 of method 100, as discussed above with respect to FIG. 1.

In block 408c, the simulation system 220 may use a current state of the plurality of fields to determine an asset allocation for each of the plurality of time segments via a neural network. This step may be the same as or similar to block 108 of method 100, as discussed above with respect to FIG. 1. In some embodiments, the system may be further configured to identify a current state of the plurality of fields, e.g., the data currently entered in the fields, in determining the asset allocation for each of the plurality of time segments.

In block 408d, the simulation system 220 may cause the user device to update the GUI with the asset allocation based on the current state of the plurality of fields, such that the asset allocation is dynamically updated with each edit of the plurality of edits, the asset allocation being configured to maximize a probability of success. In some embodiments, the system may continuously modify the GUI to generate a modified or updated GUI with the asset allocation based on the current state of the plurality of fields. In some embodiments, maximizing the probability of success may include maximizing a probability that the user will retain a threshold amount of money at the end time associated with a life event, as discussed herein. A benefit of this feature is that a user, for example, may visualize how his/her personalized glidepath may change depending on the data entered in the plurality of fields at a specific time.

### Example Use Case

The following example use case describes an example of a typical user flow pattern. This section is intended solely for explanatory purposes and not in limitation.

In one example, a person who is currently 40 years old, may expect to live to be 100 years old, and may wish to maintain a certain amount of money when the person reaches 100 years old. A system may be configured to receive a variety of data corresponding to the user's cash inflows and cash outflows, how much money the user wishes to still have by the time he/she is 100 years old, and how risk adverse the user wishes to be. The user may enter this data into a financial planning application or software via a graphical user interface (GUI) of a user device. The system may take a 60-year amount of time (100 years−40 years), and divide that amount of time into 60, one-year time segments. For each one-year time segment, the system may utilize a neural network that runs Monte Carlo simulations to simultaneously determine a respective or individual asset allocation (e.g., a split between stocks and bonds). The system may be configured to display the individual asset allocations for each time segment via the GUI, for example, as a plot or graph depicting how the asset allocations change each year over the 60-year time period. The GUI may be configured such that the user may re-enter the data, or certain portions of the data, to generate a modified GUI (e.g., showing modified plots or graphs) depicting how the new or revised data changes the individual asset allocations for each time period.

The neural network may perform backpropagation to compute sensitivities with respect to each individual time segment's asset allocation. The system may then adjust respective weights of each asset allocation by the respective computed sensitivities, and recompute the sensitivities via backpropagation until the sensitives converge at an optimal or personalized asset allocation glidepath that maximizes the probability that the user will maintain his/her desired amount of money at the age of 100 years (probability of success). Once again, the system may generate and display, via the GUI of the user device, a plot or graph depicting the personalized asset allocation glidepath.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive data corresponding to a user, the data comprising a risk tolerance and an end time associated with a life event; cause a user device to display a graphical user interface (GUI) that includes a plurality of editable fields associated with the data; monitor the plurality of editable fields for edits; dynamically generate a personalized asset allocation glidepath of the user based on the monitoring of the plurality of editable fields by, for each edit of a plurality of edits to the plurality of fields: determining an amount of time between a current time and the end time; dividing the amount of time into a plurality of time segments; using a current state of the plurality of fields to determine an asset allocation for each of the plurality of time segments via a neural network; and causing the user device to update the GUI with the asset allocation based on the current state of the plurality of fields, such that the asset allocation is dynamically updated with each edit of the plurality of edits, the asset allocation being configured to maximize a probability that the user will retain a threshold amount of money at the end time associated with the life event.

Clause 2: The system of clause 1, wherein the data further comprises one or more of financial information, income information, tax information, family information, liquidity, or combinations thereof.

Clause 3: The system of clause 1, wherein the life event comprises one or more of a lifespan, a retirement, an education, an asset purchase, a family event, a bequest, or combinations thereof.

Clause 4: The system of clause 1, wherein the amount of time is measured in years.

Clause 5: The system of clause 1, wherein the neural network is configured to perform one or more simulations based on one or more algorithms for each of the plurality of time segments.

Clause 6: The system of clause 5, wherein the one or more simulations comprise Monte Carlo simulations.

Clause 7: The system of clause 1, wherein generating the personalized asset allocation glidepath comprises: computing sensitivities with respect to each asset allocation for each of the plurality of time segments; and recomputing the sensitivities via backpropagation until the sensitives converge at the personalized asset allocation glidepath.

Clause 8: A system comprising: one or more processors; and a memory in communication with the one or more processors and storing instructions that, when executed by the one or more processors, are configured to cause the system to: receive data corresponding to a user, the data comprising a risk tolerance and an end time associated with a life event; cause a user device to display a graphical user interface (GUI) that includes a plurality of editable fields associated with the data; monitor the plurality of editable fields for edits; dynamically generate a personalized asset allocation glidepath of the user based on the monitoring of the plurality of editable fields by, for each edit of a plurality of edits to the plurality of fields: determining an amount of time between a current time and the end time; dividing the amount of time into a plurality of time segments; using a current state of the plurality of fields to determine an asset allocation for each of the plurality of time segments via a neural network; and causing the user device to update the GUI with the asset allocation based on the current state of the plurality of fields, such that the asset allocation is dynamically updated with each edit of the plurality of edits, the asset allocation being configured to maximize a probability of success.

Clause 9: The system of clause 8, wherein the data further comprises one or more of financial information, income information, tax information, family information, liquidity, or combinations thereof.

Clause 10: The system of clause 8, wherein the life event comprises one or more of a lifespan, a retirement, an education, an asset purchase, a family event, a bequest, or combinations thereof.

Clause 11: The system of clause 8, wherein the neural network is configured to perform one or more simulations based on one or more algorithms for each of the plurality of time segments.

Clause 12: The system of clause 11, wherein the one or more simulations comprise Monte Carlo simulations.

Clause 13: The system of clause 11, wherein the probability of success comprises a probability that the user will retain a threshold amount of money at the end time associated with the life event.

Clause 14: A system comprising: one or more processors; and a memory in communication with the one or more processors and storing instructions that, when executed by the one or more processors, are configured to cause the system to: receive data corresponding to a user; determine an amount of time based on the data; divide the amount of time into a plurality of time segments; determine an asset allocation for each of the plurality of time segments via a neural network based on the data, the asset allocation being configured to maximize a probability that the user will achieve a life goal; and generate a personalized asset allocation glidepath associated with the life goal based on each asset allocation for each of the plurality of time segments by: computing sensitivities with respect to each asset allocation for each of the plurality of time segments; and recomputing the sensitivities via backpropagation until the sensitives converge at the personalized asset allocation glidepath.

Clause 15: The system of clause 14, wherein the data comprises one or more of financial information, income information, tax information, family information, liquidity, risk tolerance, or combinations thereof.

Clause 16: The system of clause 14, wherein the life goal comprises retaining a threshold amount of money at an end of the amount of time.

Clause 17: The system of clause 16, wherein the end of the amount of time corresponds to one or more of a lifespan, a retirement, an education, an asset purchase, a family event, a bequest, or combinations thereof.

Clause 18: The system of clause 14, wherein the neural network is configured to perform one or more simulations based on one or more algorithms for each of the plurality of time segments.

Clause 19: The system of clause 18, wherein the one or more simulations comprise Monte Carlo simulations.

Clause 20: The system of clause 14, wherein the amount of time is measured in years.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation.” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second.” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
one or more processors; and
a memory in communication with the one or more processors and storing instructions that, when executed by the one or more processors, are configured to cause the system to:
receive data corresponding to a user, the data comprising a risk tolerance and an end time associated with a life event;
cause a user device to display a graphical user interface (GUI) that includes a plurality of editable fields associated with the data;
monitor the plurality of editable fields for edits;
dynamically generate a personalized asset allocation glidepath of the user based on the monitoring of the plurality of editable fields by, for each edit of a plurality of edits to the plurality of fields:
determining an amount of time between a current time and the end time;
dividing the amount of time into a plurality of time segments;
using a current state of the plurality of fields to determine an asset allocation for each of the plurality of time segments via a neural network; and
causing the user device to update the GUI with the asset allocation based on the current state of the plurality of fields, such that the asset allocation is dynamically updated with each edit of the plurality of edits, the asset allocation being configured to maximize a probability that the user will retain a threshold amount of money at the end time associated with the life event.

2. The system of claim 1, wherein the life event comprises one or more of a lifespan, a retirement, an education, an asset purchase, a family event, a bequest, or combinations thereof.

3. The system of claim 1, wherein the amount of time is measured in years.

4. The system of claim 1, wherein the neural network is configured to perform one or more simulations based on one or more algorithms for each of the plurality of time segments.

5. The system of claim 4, wherein the one or more simulations comprise Monte Carlo simulations.

6. The system of claim 1, wherein the data further comprises one or more of financial information, income information, tax information, family information, liquidity, or combinations thereof.

7. The system of claim 1, wherein generating the personalized asset allocation glidepath comprises:
computing sensitivities with respect to each asset allocation for each of the plurality of time segments; and
recomputing the sensitivities via backpropagation until the sensitives converge at the personalized asset allocation glidepath.

8. A system comprising:
one or more processors; and
a memory in communication with the one or more processors and storing instructions that, when executed by the one or more processors, are configured to cause the system to:
receive data corresponding to a user, the data comprising a risk tolerance and an end time associated with a life event;
cause a user device to display a graphical user interface (GUI) that includes a plurality of editable fields associated with the data;
monitor the plurality of editable fields for edits;
dynamically generate a personalized asset allocation glidepath of the user based on the monitoring of the plurality of editable fields by, for each edit of a plurality of edits to the plurality of fields:
determining an amount of time between a current time and the end time;
dividing the amount of time into a plurality of time segments;
using a current state of the plurality of fields to determine an asset allocation for each of the plurality of time segments via a neural network; and
causing the user device to update the GUI with the asset allocation based on the current state of the plurality of fields, such that the asset allocation is dynamically updated with each edit of the plurality of edits, the asset allocation being configured to maximize a probability of success.

9. The system of claim 8, wherein the data further comprises one or more of financial information, income information, tax information, family information, liquidity, or combinations thereof.

10. The system of claim 8, wherein the life event comprises one or more of a lifespan, a retirement, an education, an asset purchase, a family event, a bequest, or combinations thereof.

11. The system of claim 8, wherein the neural network is configured to perform one or more simulations based on one or more algorithms for each of the plurality of time segments.

12. The system of claim 11, wherein the one or more simulations comprise Monte Carlo simulations.

13. The system of claim 11, wherein the probability of success comprises a probability that the user will retain a threshold amount of money at the end time associated with the life event.

14. A system comprising:
one or more processors; and
a memory in communication with the one or more processors and storing instructions that, when executed by the one or more processors, are configured to cause the system to:
receive data corresponding to a user;
determine an amount of time based on the data;
divide the amount of time into a plurality of time segments;
determine an asset allocation for each of the plurality of time segments via a neural network based on the data, the asset allocation being configured to maximize a probability that the user will achieve a life goal; and
generate a personalized asset allocation glidepath associated with the life goal based on each asset allocation for each of the plurality of time segments by:
computing sensitivities with respect to each asset allocation for each of the plurality of time segments; and
recomputing the sensitivities via backpropagation until the sensitives converge at the personalized asset allocation glidepath.

15. The system of claim 14, wherein the data comprises one or more of financial information, income information, tax information, family information, liquidity, risk tolerance, or combinations thereof.

16. The system of claim 14, wherein the life goal comprises retaining a threshold amount of money at an end of the amount of time.

17. The system of claim 16, wherein the end of the amount of time corresponds to one or more of a lifespan, a retirement, an education, an asset purchase, a family event, a bequest, or combinations thereof.

18. The system of claim 14, wherein the neural network is configured to perform one or more simulations based on one or more algorithms for each of the plurality of time segments.

19. The system of claim 18, wherein the one or more simulations comprise Monte Carlo simulations.

20. The system of claim 14, wherein the amount of time is measured in years.
